(19) United States
(12) Patent Application Publication
(10) Pub. No.: US 2020/0250524 A1
(43) Pub. Date: Aug. 6, 2020

(54) SYSTEM AND METHOD FOR REDUCING COMPUTATIONAL COMPLEXITY OF NEURAL NETWORK

(71) Applicant: NATIONAL CHENG KUNG UNIVERSITY, Tainan City (TW)

(72) Inventor: WEN-LONG CHIN, TAINAN CITY (TW)

(21) Appl. No.: 16/415,005

(22) Filed: May 17, 2019

(30) Foreign Application Priority Data
Jan. 31, 2019 (TW) 108103885

(51) Int. Cl. G06N 3/08

(52) U.S. Cl. CPC G06N 3/08

(57) ABSTRACT

A system and a method for reducing computational complexity of neural networks are revealed. The method includes the steps of inputting weight values, input values and an enable signal into a first accumulator for starting inner product computation of the weight values and the input values by the enable signal and then performing a shift of the weight values and the input values; shifting a deviation value and performing an add operation of the shifted deviation value and both the weight values and the input values already being processed to get a first output value; and checking if the first output value is less than a threshold value and outputting a result value of zero (0) if the first output value is less than the threshold value. Thereby computational power of the neural network is decreased owing to omission of a part of computational process.

### BACKGROUND OF THE INVENTION

### Field of the Invention

The present invention relates to a system and a method for reducing computational complexity of neural networks, especially to a system and a method for reducing computational complexity of neural networks to reduce computational power. The present system and the method that saves the computational cost of the neural networks while maintaining the same performance can be applied to the information and communication related fields.

### Description of Related Art

In recent years, Deep Neural Network (DNN) has received great attention, applied to various fields and practiced in our daily lives. For example, DNN is broadly used in autonomous cars, medical image processing, voice recognition in communication, etc. During operation of the neural network, the main and densest computation is multiplication between matrices and vectors. For example, a filtering process in Convolutional Neural Networks (CNN) can be considered as the inner product of vectors while a fully connected network can be considered as the matrix-vector product.

Due to wide applications of the neural networks, the neural network has higher requirements for hardware/software for reducing processing complexity and communication cost while being used to process more information with higher computational complexity. Refer to Taiwanese Pat. Pub. No. TW 201839675 A “method and system for reducing computational complexity of Convolutional Neural Network”, a CNN used for classification of input images is revealed. Kernels and redundancy in feature maps are used to reduce the computational complexity. During the operation, certain multiply accumulate (MAC) operation is omitted. That means one of the operands in the multiplication is set as zero. Also refer to Taiwanese Pat. Pub. No. TW 201835817 A “apparatus and method for designing super resolution Deep Convolutional Neural Network”, the complexity of storage and computation is reduced by cascade network trimming. The conventional convolutional operation is replaced by arrangement of dilated Convolution. The operation efficiency of the super resolution Deep Convolutional Neural Networks is further improved for further refinement of the super resolution convolutional neural network model processed by cascade network training. Thus the complexity of the super resolution convolutional neural network model processed by cascade network training is reduced.

In the neural network field, most of the studies now focus on reduction of the computational complexity. Thus there is a room for improvement and there is a need to provide a system or a method that reduces computational complexity of neural networks for attaining lower processing power and lower cost of hardware/software while the neural networks being applied to various fields.

### SUMMARY OF THE INVENTION

Therefore it is a primary object of the present invention to provide a system and a method for reducing computational complexity of neural networks in which a partial result value is obtained by computation based on a plurality of weight values and a plurality of input values. If the partial result value obtained is less than a preset threshold value, the rest computation can be omitted so as to reduce computational complexity of the whole neural network.

In order to achieve the above object, a method for reducing computational complexity of neural networks according to the present invention includes a plurality of steps. A plurality of weight values, a plurality of input values and an enable signal are input into an accumulator for starting inner product computation of the weight values and the input values by the enable signal and then performing a shift of both the weight values and the input values. Then carry out a shift operation of a deviation value and perform an add operation of the shifted deviation value and both the weight values and the input values that are already being processed by the inner product computation and the shift operation so as to get a first output value. Next check whether the first output value is less than a threshold value and output a result value of zero (0) if the first output value is smaller than the threshold value. Once the first output value is greater than or equal to the threshold value, the second output value will be calculated for getting the result value.

In order to achieve the above object, a system for reducing computational complexity of neural networks according to the present invention includes a first accumulating device, a second accumulating device, a comparison module electrically connected to the first accumulating device, an output compute module electrically connected to both the first accumulating device and the second accumulating device, and a multiplexer electrically connected to the comparison module and the output compute module. The first accumulating device is composed of a first accumulator, a plurality of first shift modules and a first adder electrically connected to the first shift modules. One of the first shift modules is electrically connected to the first accumulator and another first shift module receives a first deviation value. The second accumulating device consists of a plurality of second accumulators, a second shift module and a plurality of second adders electrically connected to the second shift module. Two of the second accumulators are electrically connected to one of the second adders while another second adder is electrically connected to another second accumulator and receiving a second deviation value.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is a schematic drawing showing structure of an embodiment according to the present invention;

FIG. 2 is a schematic drawing showing structure of an accumulating device of an embodiment according to the present invention;

FIG. 3 is a curve diagram of a rectified linear unit (ReLU) of an embodiment according to the present invention.

### DETAILED DESCRIPTION OF THE PREFERRED EMBODIMENT

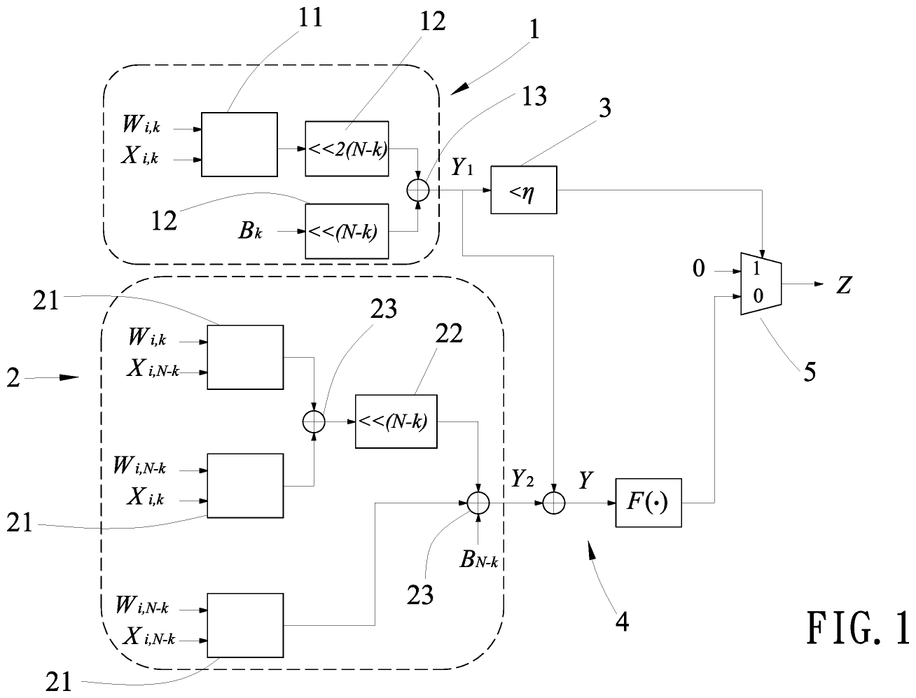

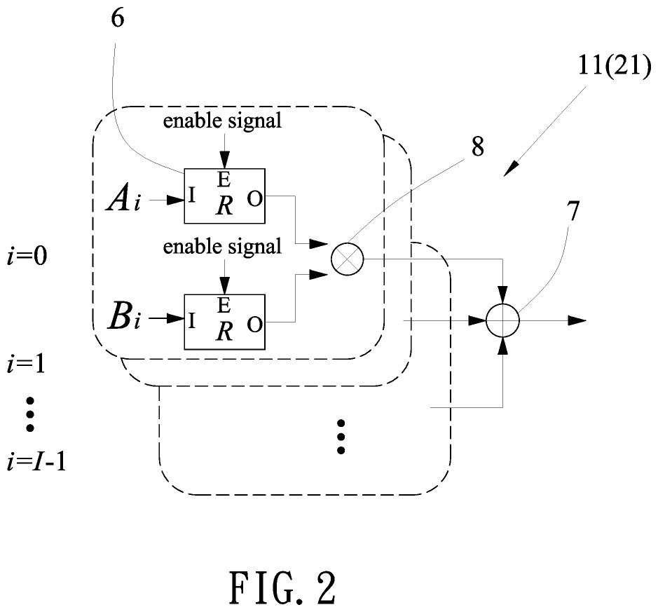

Refer to FIG. 1 and FIG. 2, a method for reducing computational complexity of neural networks according to the present invention includes the following steps. First input a plurality of weight values, a plurality of input values and an enable signal into a first accumulator 11 for starting the inner product computation of the weight values and the input values by the enable signal and then performing a shift operation of both the weight values and the input values. Carry out a shift operation of a deviation value and perform an add operation of the shifted deviation value and both the weight values and the input values that are already being processed by the inner product computation and the shift operation so as to get a first output value. Next check whether the first output value is less than a threshold value. If the first output value is smaller than the threshold value, a result value of zero (0) is output.

The first accumulator 11 consists of at least one register 6, a multiplier 8 electrically connected to the register 6, and an adder 7 electrically connected to the multiplier 8. The register 6 receives not only one of the input values or one of the weight values but also the enable signal.

A system for reducing computational complexity of neural networks according to the present invention includes a first accumulating device 1, a second accumulating device 2, a comparison module 3, an output compute module 4, and a multiplexer 5. The first accumulating device 1 consists of a first accumulator 11, a plurality of first shift modules 12 and a first adder 13 electrically connected to the first shift modules 12. One of the first shift modules 12 is electrically connected to the first accumulator 11 and another one of the first shift modules 12 receives a first deviation value. The second accumulating device 2 is composed of a plurality of second accumulators 21, a second shift module 22 and a plurality of second adders 23 electrically connected to the second shift module 22. Two of the second accumulators 21 are electrically connected to one of the second adders 23 while another second adder 23 is electrically connected to another second accumulator 21 and receiving a second deviation value. The comparison module 3 is electrically connected to the first accumulating device 1 and used for checking if an output value from the first accumulating device 1 is less than or greater than a threshold value. The output compute module 4 is electrically connected to both the first accumulating device 1 and the second accumulating device 2. The multiplexer 5 is electrically connected to the comparison module 3 and the output compute module 4.

Both the first accumulator 11 and each of the second accumulators 21 include at least one register 6, a multiplier 8 electrically connected to the register 6 and an adder 7 electrically connected to the multiplier 8. The register 6 not only receives one input value or one weight value but also receives an enable signal.

Human neurons connect to other nuclei through dendrites and axons for information transmission. In the neural network, Y, Xᵢ and Wᵢ represent an output axon, an input dendrite and synapse of the neuron respectively. Y, Xᵢ, Wᵢ and B can also be called the output value, the input value, the weight value, and the deviation value respectively. The deviation value B that makes the neural network have higher processing efficiency and saves the value of +1 therein doesn't connect to any layer of the neutral network. When the input value is zero (0), the deviation value is used to perform a leftward shift or a rightward shift of the activation function. Thereby the output value is generated only when the input value is over a preset threshold.

Refer to FIG. 1 and FIG. 2, a system for reducing computational complexity of neural networks according to the present invention includes the first accumulating device 1 and the second accumulating device 2, each of which receives a plurality of different input values, weight values and deviation values. The first accumulating device 1 is used to calculate a first output value Y₁ while the second accumulating device 2 is used to calculate a second Y₂. After the first output value Y₁ and the second Y₂ being computed by the output compute module 4, an output value Y is obtained. Then the output value Y is processed by the multiplexer 5 to generate a result value Z. The following equation 1 represents the computation of the first output value Y₁ and the second Y₂.

$${Y}_{1} = ( {\sum }_{t = 0}^{t - 1} {W}_{t , k} {X}_{t , k} ) \times {2}^{2 ( N - k )} + {B}_{k} \times {1}^{N - k} \\ {Y}_{2} = [ {\sum }_{t = 0}^{t - 1} ( {W}_{t , k} {X}_{t , N - k} + {W}_{t , N - k} {X}_{t , k} ) ] \times {2}^{N - k} + ( {\sum }_{t = 0}^{t - 1} {W}_{t , N - k} {X}_{t , N - k} ) + {B}_{N - k} \qquad Equation 1$$

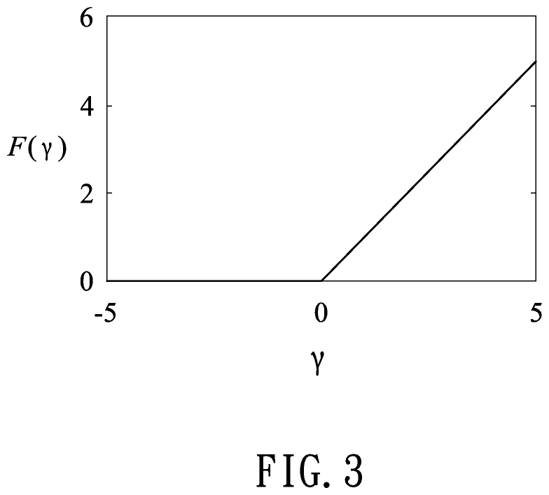

In the present invention, the computational process by which the second accumulating device 2 generates the second output value Y₂ can be omitted when the first output value Y₁ is less than the threshold value. Refer to FIG. 3, a saturation curve of a rectified linear unit (ReLU) is revealed. The characteristic of the ReLU is shown in the figure. When the input value of the ReLU (F(Y)) is smaller than zero (0), the output value of the ReLU attains the minimum value of 0. Based on this characteristic, the computational complexity is reduced when the ReLU is used.

In practice, a plurality of different weight values, a plurality of input values and an enable signal are input into a first accumulating device 1 so that inner product computation of the weight values and the input values is performed owing to the enable signal. As shown in FIG. 2, the first accumulating device 1 includes at least two registers 6 for receiving a weight value and an input value, respectively. The weight value and the input value are computed in the multiplier 8. Other weight values and other input values are also processed in the same way. All the results obtained after operation of the multiplier 8 are further computed by the adder 7 and then to be output. The output result is shifted 2(N−k) to the left by the first shift module 12. N is the bit of the original computational complexity and k represents the bit width of inputs, weights, and the deviation value used to calculate Y₁.

Next input a deviation value to another shift module so that the deviation value is shifted N-k to the left. Then both the weight values and the input values that are already being processed by the inner product computation and the shift operation as well as the shifted deviation value are input into the first adder 13 to carry out an add operation and get a first output value Y₁. The first output value Y₁ is transmitted to the comparison module 3 which is electrically connected to the first accumulating device 1 for checking if the first output value Y₁ is less than a threshold value η. If the first output value Y₁ is less than a threshold value η, it is confirmed that the results value Z is zero (0). Thus the computational process of the second output value Y₂ can be omitted and the whole computational complexity is reduced. Once the first output value Y₁ is greater than or equal to the threshold value η, the second accumulating device 2 performs the computation to get the second output value Y₂ and further the result value Z.

In order to get the first output value Y₁, the bit value k and the threshold value η should be learned first and calculated by the function (1−(k/N)²)Pₛ. This function gets the maximum result under the constraint that Pₑ is smaller than an upper limit such as 0.01 (Pₑ≤0.01). Pₛ is defined as the power saving probability, representing the probability that Y₁ is smaller than η (Y₁<η)). Pₑ is defined as the detection error probability, representing the probability that Y₁<η and Y≥0. Thereby the error probability is reduced and the better power saving probability is achieved. The bit value k obtained is ranging from 2, 3 to N while the threshold value η is ranging from 0 to −0.2 with the interval of 0.0125. In other words, the method finds out a set of bit value k and threshold value η that achieves the optimal power saving probability under the condition that the error probability reaches the upper limit. In this embodiment, it is learned that the threshold value η is smaller than zero (0). For example, the bit value is taken as 5 and the threshold value is taken as −0.0375 when the input values and the deviation values are generated by uniformly distributed random variables in the (−0.5,0.5) interval while the weight values are generated by Gaussian (normally) distributed random variable with the mean of the Gaussian distribution 0, the variance=1, I=256, and N=12. Thereby the result value Z is directly output as zero (0) if the first output value Y₁ is less than the threshold value η.

Moreover, the bit value k and the threshold value η can also be learned by E[|Z−Z₁], wherein Z₁ is the result value obtained by conventional computation of Y, the absolute value |Z−Z₁| is the error between the result value of the conventional computation and the results value of the present invention, and E[⋅] is the expected value. The expected value function E[|Z−Z₁|] of the above error is also limited to be less than an upper limit such as 0.01 so that the bit value k and the threshold value η are defined.

Compared with the techniques available now, the present invention has the following advantages:

1. In the present invention, the computational process of the second output value can be omitted when the first output value obtained by the accumulator is less than the threshold value. Thereby the processing power of the neural network can be reduced owing to the reduced computational complexity.
2. The system and the method for reducing computational complexity of neural networks according to the present invention can be applied to information and communication of the internet of things (IoT). The spectrum sensing is carried out in the information and communication field to check the proper spectrum based on cost, bandwidth, signal rate and signal modulation for reducing processing cost of information and communication of the IoT.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalent.

What is claimed is:

1. A method for reducing computational complexity of neural networks comprising the steps of:
inputting a plurality of weight values, a plurality of input values and an enable signal into a accumulator for starting the inner product computation of the weight values and the input values by the enable signal and then performing a shift operation of both the weight values and the input values, wherein the accumulator includes at least one register, a multiplier electrically connected to the register, and an adder electrically connected to the multiplier; the register receives not only one of the input values or one of the weight values but also the enable signal;
shifting a deviation value and performing an add operation of the shifted deviation value and both the weight values and the input values that are already being processed by the inner product computation and the shift operation so as to generate a first output value; and
checking if the first output value is less than a threshold value and outputting a result value of zero (0) if the first output value is less than the threshold value.

2. A system for reducing computational complexity of neural networks comprising:
a first accumulating device having a first accumulator, a plurality of first shift modules and a first adder electrically connected to the first shift modules;
a second accumulating device including a plurality of second accumulators, a second shift module and a plurality of second adders electrically connected to the second shift module;
a comparison module that is electrically connected to the first accumulating device;
an output compute module electrically connected to both the first accumulating device and the second accumulating device; and
a multiplexer that is electrically connected to the comparison module and the output compute module;
wherein one of the first shift modules is electrically connected to the first accumulator and another one of the first shift modules receives a first deviation value; wherein two of the second accumulators are electrically connected to one of the second adders while another one of the second adders is electrically connected to another one of the second accumulators and receives a second deviation value.

3. The system as claimed in claim 2, wherein the first accumulator and each of the second accumulators both include at least one register, a multiplier electrically connected to the register, and an adder electrically connected to the multiplier; the register receives not only an input value or a weight value but also an enable signal.

4. The system as claimed in claim 2, wherein the comparison module is used for determining the output value and the threshold value from the first accumulating device and a threshold value and comparing the output value relative to the threshold value.
